(19) United States
(12) Patent Application Publication
(10) Pub. No.: US 2011/0176744 A1
(43) Pub. Date: Jul. 21, 2011

(54) Apparatus and method for image interpolation using anisotropic gaussian filter

(75) Inventors: Sung-Jea Ko, Seoul (KR); Jong-Woo Han, Seoul (KR); Sung-Hyun Cheon, Seoul (KR); Tae-Shick Wang, Gyeonggi-do (KR)

(73) Assignee: KOREA UNIVERSITY RESEARCH AND BUSINESS FOUNDATION, Seoul (KR)

(21) Appl. No.: 12/657,753

(22) Filed: Jan. 27, 2010

(30) Foreign Application Priority Data
Jan. 20, 2010 (KR) 10-2010-0005260

(51) Int. Cl. G06K 9/40; G06K 9/32

(52) U.S. Cl. 382/264; 382/300

(57) ABSTRACT

An apparatus and method for image interpolation using an anisotropic Gaussian filter, the image interpolation apparatus including: an edge information calculator calculating a first edge orientation that is an orientation of an edge of each of a plurality of pixels that constitute an input low resolution image, and first edge orientation energy that is a maximal strength of the edge corresponding to the first edge orientation; an image enlarging unit calculating a second edge orientation and second edge orientation energy of each of pixels to be interpolated, which are obtained by subtracting reference pixels corresponding to each of the pixels of the low resolution image among a plurality of pixels that constitute the high resolution image that is obtained by enlarging the low resolution image, based on the first edge orientation and the first edge orientation energy of the adjacent reference pixels; and a pixel value calculator calculating a value of each of the pixels to be interpolated, by using an interpolation filter having a direction and a width determined according to the second edge orientation and the second edge orientation energy of each of the pixels to be interpolated. The Gaussian filter having a direction and a width that are adaptively adjusted according to an orientation and strength of an edge is used to interpolate values of pixels of a high resolution image that is obtained by image enlargement so that deterioration of image quality can be minimized with a small amount of calculation and an image with high quality and high resolution can be generated.

### CROSS-REFERENCE TO RELATED PATENT APPLICATION

This application claims the benefit of Korean Patent Application No. 10-2010-0005260, filed on Jan. 20, 2010, in the Korean Intellectual Property Office, the disclosure of which is incorporated herein in its entirety by reference.

### BACKGROUND OF THE INVENTION

1. Field of the Invention

The present invention relates to an apparatus and method for image interpolation using an anisotropic Gaussian filter, and more particularly, to an image interpolation apparatus and method by which a high resolution image is obtained by enlarging a low resolution image.

2. Description of the Related Art

As image display devices have increasing resolution, a consumer's demand for viewing a high resolution image increases. Also, a demand for viewing an image obtained by an apparatus for obtaining a low resolution image, such as a mobile phone or a web-cam, via a large-sized image display device, such as a television (TV) or the like, is increasing.

Bilinear interpolation and bicubic interpolation that are most representative technologies among conventional image enlargement technologies have a small amount of calculation, are easily performed and thus are widely used. However, blur or jagging occurs in a high resolution image that is obtained using bilinear and bicubic interpolation and thus, satisfactory results cannot be obtained.

In order to solve these problems, many researches have been done. Among these researches, a super-resolution image reconstruction (SR) technology has been widely studied. In an SR technology, the relationship between various low resolution reference images is found, and a high resolution image is obtained using the relationship and then, an image with high quality and high resolution is generated by additionally performing post processing. However, the SR technology requires a large amount of calculation, reference images, and a space in which the reference images are stored. In order to overcome the drawbacks, an SR technology using one image and previously-acquired information has been developed. However, the SR technology using one image and the previously-acquired information also requires a large amount of calculation and a space in which the previously-acquired information is stored.

Meanwhile, there are conventional image interpolation technologies, such as image interpolation using polynomials, image interpolation using image reconstruction, and image interpolation based on edge of an image.

Image interpolation using polynomials has been developed on the assumption that values of adjacent pixels are similar and will vary continuously. However, the assumption is not applied to edge of the image, and thus blur occurs frequently. Thus, in image interpolation using polynomials, image contrast ratio improvement technologies have to be additionally used as post processing.

Image interpolation using image reconstruction has been developed on the assumption that, in an idealistic case, an original image and an image that is obtained by reducing the interpolated original image are the same. In other words, in image interpolation using image reconstruction, a high resolution image is interpolated to minimize an error between two images and thus, a high quality image can be obtained. However, in image interpolation using image reconstruction, repetitive image interpolation and reduction has to be performed. Thus, the amount of calculation increases, and wrong image results are obtained due to local minimum.

Last, in image interpolation based on edge of the image, first, the edge is implicitly and explicitly found, and the images are adaptively interpolated to the edge so that a high resolution image can be obtained. Image interpolation based on the edge is easily performed and thus is widely used. However, there is a difference between performances of image interpolation based on the edge of the image according to a technology for finding the edge.

In order to solve the above-mentioned problems, a method of obtaining a high resolution image in which blur and jagging do not frequently occur, from a low resolution image with a small amount of calculation is required.

### SUMMARY OF THE INVENTION

The present invention provides an apparatus and method for image interpolation using an anisotropic Gaussian filter, whereby a high resolution image in which blur and jagging do not frequently occur, can be obtained from a low resolution image with a small amount of calculation.

The present invention also provides a computer readable recording medium having recorded thereon a program for executing the image interpolation method.

According to an aspect of the present invention, there is provided an image interpolation apparatus including: an edge information calculator calculating a first edge orientation that is an orientation of an edge of each of a plurality of pixels that constitute an input low resolution image, and first edge orientation energy that is a maximal strength of the edge corresponding to the first edge orientation; an image enlarging unit calculating a second edge orientation and second edge orientation energy of each of pixels to be interpolated, which are obtained by subtracting reference pixels corresponding to each of the pixels of the low resolution image among a plurality of pixels that constitute the high resolution image that is obtained by enlarging the low resolution image, based on the first edge orientation and the first edge orientation energy of the adjacent reference pixels; and a pixel value calculator calculating a value of each of the pixels to be interpolated, by using an interpolation filter having a direction and a width determined according to the second edge orientation and the second edge orientation energy of each of the pixels to be interpolated.

According to another aspect of the present invention, there is provided an image interpolation method including: calculating a first edge orientation that is an orientation of an edge of each of a plurality of pixels that constitute an input low resolution image, and first edge orientation energy that is a maximal strength of the edge corresponding to the first edge orientation; calculating a second edge orientation and second edge orientation energy of each of pixels to be interpolated, which are obtained by subtracting reference pixels corresponding to each of the pixels of the low resolution image among a plurality of pixels that constitute the high resolution image that is obtained by enlarging the low resolution image, based on the first edge orientation and the first edge orientation energy of the adjacent reference pixels; and calculating a value of each of the pixels to be interpolated, by using an interpolation filter having a direction and a width determined according to the second edge orientation and the second edge orientation energy of each of the pixels to be interpolated.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an image interpolation apparatus using an anisotropic Gaussian filter according to an embodiment of the present invention;

FIG. 2 is an image of an edge detection filter that is used by an edge information calculator;

FIG. 3 illustrates the relationship between positions of a reference pixel and a pixel to be interpolated, which belong to a high resolution image;

FIG. 4 illustrates a Gaussian filter used in an image to be interpolated;

FIG. 5 illustrates shapes of Gaussian filters according to the relationship between positions of a pixel to be interpolated and an edge;

FIG. 6 is a flowchart illustrating an image interpolation method using an anisotropic Gaussian filter according to an embodiment of the present invention;

FIGS. 7A through 7F are test images that are used in experiments for evaluating the performance of the image interpolation apparatus of FIG. 1;

FIGS. 8A through 8D are images that are obtained when the image interpolation apparatus of FIG. 1 is used in an image ‘fruit’ of FIG. 7A, according to operations;

FIG. 9 is images that are obtained by using the image interpolation method of FIG. 6 and conventional image interpolation methods, respectively, in an image ‘cycle’ having the size of 160×80 of FIG. 7B;

FIG. 10 is images that are obtained by using the image interpolation method of FIG. 6 and the conventional image interpolation methods, respectively, in an image ‘cafe’ of FIG. 7C; and

FIG. 11 is images that are obtained by using the image interpolation method of FIG. 6 and the conventional image interpolation methods, respectively, in an image ‘bike’ of FIG. 7D.

### DETAILED DESCRIPTION OF THE INVENTION

Hereinafter, the present invention will be described in detail by explaining exemplary embodiments of the invention with reference to the attached drawings.

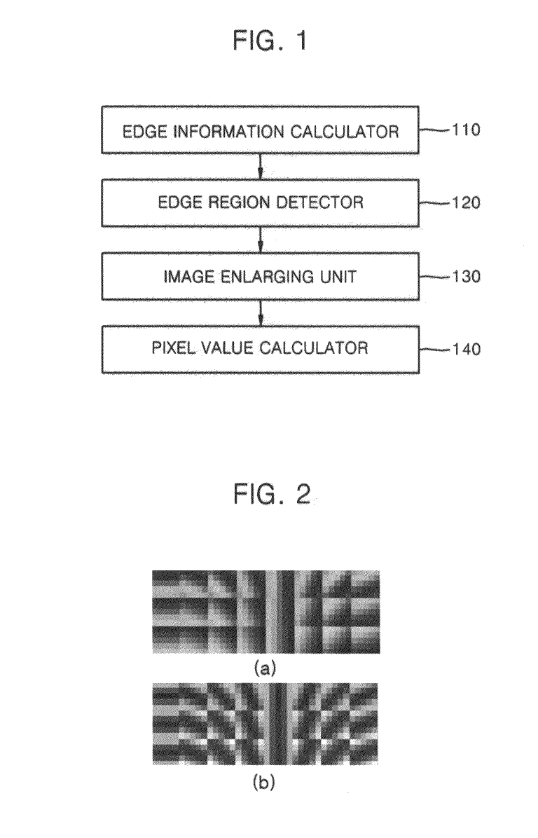

FIG. 1 is a block diagram of an image interpolation apparatus using an anisotropic Gaussian filter according to an embodiment of the present invention. Referring to FIG. 1, the image interpolation apparatus according to the present embodiment includes an edge information calculator 110, an edge region detector 120, an image enlarging unit 130, and a pixel value calculator 140.

The edge information calculator 110 calculates a first edge orientation that is an orientation of an edge of each of a plurality of pixels that constitute an input low resolution image, and first edge orientation energy that is a maximal strength of the edge corresponding to the first edge orientation.

When a high resolution image is generated by enlarging the low resolution image, values of pixels to be interpolated, which are to be inserted between reference pixels corresponding to the pixels of the low resolution image, need to be calculated from the high resolution image. A Gaussian filter is used to interpolate values of pixels of an enlarged image. In the present invention, the values of the pixels to be interpolated are calculated using an anisotropic Gaussian filter having a direction and a width that vary according to a orientation and a strength of an edge that is obtained from each of the pixels to be interpolated.

In order to determine the direction and the width of the anisotropic Gaussian filter, information about the orientation and the strength of the edge that is obtained from each of the pixels to be interpolated is required. The information about the edge that is obtained from each of the pixels to be interpolated is obtained from information about an edge of each of a plurality of pixels that constitute an image before the high resolution image is generated, i.e., the low resolution image before image enlargement. The edge information calculator 110 is provided to calculate the information about the edge of each of the pixels that constitute the low resolution image.

The first edge orientation is an orientation of an edge in which each of the pixels of the low resolution image is disposed, or an orientation of an edge that is the closest to each of the pixels of the low resolution image. The first edge orientation energy is the maximal strength of the edge. Various methods are used to calculate the orientation and the strength of the edge detected from the low resolution image. In the present invention, the first edge orientation and the first edge orientation energy are calculated using a Leung-Malik filter (hereinafter, referred to as an LM filter) that is an edge detection filter including a plurality of filter banks that are determined according to a orientation and a scale of an edge.

The LM filter includes 36 orientation filters (first-order and second-order Gaussian derivatives with respect to six orientations, three scales, and two phases), 8 laplacian of Gaussian (LoG) filters, and 4 Gaussian filters. In order to improve accuracy of edge orientation detection, the number of orientation filters according to the orientation and the scale of the edge increases, and LoG and Gaussian filters that indicate a flat region are disabled so that complexity of calculation may be reduced.

As a representative embodiment, the edge detection filter that is used in the present invention includes 48 filter banks with respect to 8 orientations and 3 scales at intervals of 22.5° from −90° to 67.5°. FIG. 2 is an image of an edge detection filter that is used by the edge information calculator 110 of the image interpolation apparatus of FIG. 1. (a) of FIG. 2 is a first-order Gaussian derivative with respect to 8 orientations and 3 scales, and (b) of FIG. 2 is a second-order Gaussian derivative with respect to 8 orientations and 3 scales.

The edge information calculator 110 calculates energy according to an orientation and a scale of each of the pixels of the low resolution image by using the edge detection filter so as to calculate edge information about each of the pixels of the low resolution image, as shown in Equation 1:

E_{σ,θ}(x,y)=I_{L}(x,y)*f_{σ,θ} (1)

, where E_{σ,θ}(x, y) is energy according to an orientation θ and a scale a of a (x,y)^{th} pixel of the low resolution image, and I_{L}(x, y) is a value of the (x,y)^{th} pixel of the low resolution image, and f_{σ,θ} is the edge detection filter according to the orientation θ and the scale σ.

If a value of energy according to the orientation and the scale of each of the pixels of the low resolution image is calculated by using Equation 1, a first edge orientation is determined to maximize the value of the energy, as shown in Equation 2:

$${α}_{L} ( x , y ) = arg {max}_{θ ∈ {Ω}_{θ}} {E}_{σ , θ} ( x , y ) , \qquad ( 2 )$$

where α_{L}(x,y) is the first edge orientation of the (x,y)^{th} pixel of the low resolution image, and Ω_{θ} is candidate orientations with respect to the first edge orientation, i.e., the above-described 8 orientations.

Next, the first edge orientation energy is determined as a maximal value of energy values that are calculated by using Equation 1 according to the first edge orientation and the scale. In other words, the first edge orientation energy may be calculated by using Equation 3:

$${β}_{L} ( x , y ) = {max}_{σ ∈ {Ω}_{σ}} \{ {E}_{σ , {α}_{L} ( x , y )} ( x , y ) \} , \qquad ( 3 )$$

where β_{L}(x,y) is the first edge orientation energy of the (x,y)^{th} pixel of the low resolution image, and c is candidate scales for determining the first edge orientation energy, i.e., the above-described three scales.

Next, the edge region detector 120 detects an edge region that is a region including pixels having the first edge orientation energy that is equal to or greater than predetermined reference energy, among a plurality of pixels that constitute the low resolution image.

When a difference between edge orientation energy with respect to each edge orientation is not large, the edge orientation energy is easily fluctuated due to noise. Thus, the edge orientation may be inaccurately estimated, and thus artifacts occur in the high resolution image. In order to solve the problem, each of the pixels of the low resolution image is classified into an edge region and a flat region based on the value of the first edge orientation energy that is calculated with respect to each of the pixels of the low resolution image. In other words, only pixels having the value of the first edge orientation energy that is greater than the predetermined reference energy are detected to generate the edge region, as shown in Equation 4:

$$F ( x , y ) = \{ \begin{matrix}0 , & if {β}_{L} ( x , y ) < T \\ 1 , & otherwise ,\end{matrix} \qquad ( 4 )$$

where F(x,y) is a pixel of a binary image corresponding to the (x,y)^{th} pixel of the low resolution image, and T is predetermined reference energy and is determined experimentally.

In detail, the edge region detector 120 generates the binary image from the low resolution image, and a pixel of the low resolution image corresponding to a pixel having a value of 1 at the binary image belongs to the edge region. The image enlarging unit 130 that will be described later calculates an edge orientation with respect to each of the pixels of an image that is enlarged by using only the first edge orientation that is calculated with respect to the pixel that belongs to the edge region.

The image enlarging unit 130 calculates a second edge orientation and second edge orientation energy of each of pixels to be interpolated, which are obtained by subtracting reference pixels corresponding to each of the pixels of the low resolution image among a plurality of pixels that constitute the high resolution image that is obtained by enlarging the low resolution image, based on the first edge orientation and the first edge orientation energy of the adjacent reference pixels.

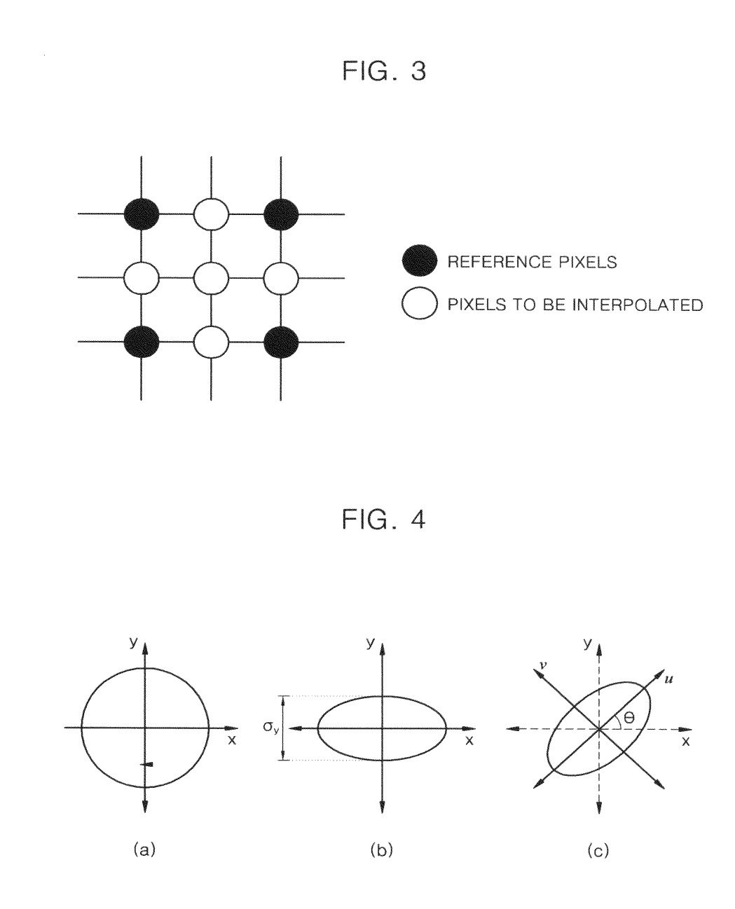

When the high resolution image is generated by enlarging the low resolution image, as described above, in the high resolution image, new pixels to be interpolated are inserted between the reference pixels corresponding to each of the pixels of the low resolution image. FIG. 3 illustrates the relationship between positions of a reference pixel and a pixel to be interpolated, which belong to the high resolution image, wherein one pixel to be interpolated is inserted between the adjacent reference pixels. Thus, FIG. 3 corresponds to a case where the low resolution image is enlarged twice, i.e., a case where a value of a scaling factor is 2. When the value of the scaling factor increases, the number of pixels to be interpolated, which are to be inserted between the adjacent reference pixels, increases.

In order to determine the direction and the width of the Gaussian filter that is used to calculate values of pixels to be interpolated, which belong to the high resolution image and are to be inserted between the adjacent reference pixels, edge information of the pixels to be interpolated is required, and the edge information of the pixels to be interpolated is obtained from edge information that is calculated with respect to the reference pixels, i.e., each of the pixels of the low resolution image.

An edge orientation of each of the pixels of the high resolution image needs to gradually vary in order to prevent artifacts such as jagging. Thus, geometric constraints for suppressing a rapid variation of the edge orientation when the high resolution image is generated from the low resolution image are used as weighting factors. Also, the reliability of an edge is considered to accurately obtain the edge orientation from the high resolution image. The edge orientation that is estimated from a dominant edge has high resolution and thus, edge information of the dominant edge contributes more to edge information estimation of the high resolution image than other edges. The reliability of the edge may be estimated from the edge orientation energy.

As a result, the first edge orientation energy of the reference pixels as well as geometric distance information with the adjacent reference pixels is used to calculate the second edge orientation of the pixels to be interpolated, from the high resolution image. The second edge orientation of each of the pixels to be interpolated, of the high resolution image is calculated by using Equation 5:

$${α}_{H} ( i , j ) = ( ( 1 - t ) ( ( 1 - s ) {α}_{L} ( x , y ) {β}_{L} ( x , y ) F ( x , y ) + s {α}_{L} ( x + 1 , y ) {β}_{L} ( x + 1 , y ) F ( x + 1 , y ) ) + t ( ( 1 - s ) {α}_{L} ( x , y + 1 ) {β}_{L} ( x , y + 1 ) F ( x , y + 1 ) + s {α}_{L} ( x + 1 , y + 1 ) {β}_{L} ( x + 1 , y + 1 ) F ( x + 1 , y + 1 ) ) ) / K , \qquad ( 5 )$$

where α_{H}(i,j) is a second edge orientation of an (i,j)^{th} pixel to be interpolated, of the high resolution image, and α_{L}(i,j) is a first edge orientation of an (x,y)^{th} pixel of the low resolution image, i.e., an (x,y)^{th} pixel of the high resolution image and has the relationship of (i,j)υ[x,x+1],[y,y+1].

Also, weighting factors t and s that are the geometric constraints are defined by using Equation 6:

$$t = \frac{2 y + 1 - j}{2} , \\ s = \frac{2 x + 1 - i}{2} . \qquad ( 6 )$$

Last, a normalization factor K is defined by using Equation 7:

$$K = ( 1 - t ) ( ( 1 - s ) {β}_{L} ( x , y ) F ( x , y ) + s {β}_{L} ( x + 1 , y ) F ( x + 1 , y ) ) + t ( ( 1 - s ) {β}_{L} ( x , y + 1 ) F ( x , y + 1 ) + s {β}_{L} ( x + 1 , y + 1 ) F ( x + 1 , y + 1 ) ) . \qquad ( 7 )$$

As shown in Equation 5, the (i,j)^{th} pixel to be interpolated is disposed inside a rectangle having vertices of an (x,y)^{th} reference pixel, an (x+1,y)^{th} reference pixel, an (x,y+1)^{th} reference pixel, and an (x+1,y+1)^{th} reference pixel, respectively. In other words, the image enlarging unit 130 generates a plurality of unit cells so that the reference pixels may be disposed in the vertices of the high resolution image, and calculates a second edge orientation of each of the pixels to be interpolated, based on a first edge orientation and first edge orientation energy of the reference pixels that are disposed in the vertices of the unit cells to which each of the pixels to be interpolated belongs.

When each of the pixels to be interpolated is disposed at a boundary between two adjacent unit cells, reference pixels to be referred to so as to calculate the second edge orientation may matter. However, in this case, the second edge orientation of each of the pixels to be interpolated may be calculated based on the first edge orientation and the first edge orientation energy of the reference pixels that are adjacent to each of the pixels to be interpolated along the boundary at which each of the pixels to be interpolated is disposed.

For example, referring to FIG. 3, a pixel to be interpolated, which is disposed in the rightmost position of five pixels to be interpolated, which belong to unit cells formed by four reference pixels, is at a side of the unit cells. The second edge orientation of the pixel to be interpolated may be calculated based on edge information of two reference pixels that are disposed on or under the side of the unit cells along the side of the unit cells.

Next, the second edge orientation energy with respect to each of the pixels to be interpolated, of the high resolution image is calculated based on the second edge orientation energy of reference pixels that are disposed at vertices of the unit cells to which each of the pixels to be interpolated belongs, in the same manner as a manner for calculating the second edge orientation. Unlike in a case where the second edge orientation is calculated, it is not considered whether the reference pixels are included in the edge region, and the first edge orientation energy of all of the reference pixels is considered.

The second edge orientation energy is calculated by using Equation 8:

β_{H}(i,j)=((1−t)1−s)β_{L}(x,y)+sβ_{L}(x+1,y))+t((1−s)β_{L}(x,y+1)+sβ_{L}(x+1,y+1))) (8)

, where β_{H}(i,j) is second edge orientation energy of an (i,j)^{th} pixel to be interpolated, of the high resolution image, and β_{L}(i,j) is first edge orientation energy of an (x,y)^{th} pixel of the low resolution image, i.e., an (x,y)^{th} pixel of the high resolution image, and weighting factors t and s are defined by using Equation 6.

When an operation of calculating the second edge orientation by using Equation 5 and an operation of calculating the second edge orientation energy by using Equation 8 are iteratively performed on all of the pixels to be interpolated, of the high resolution image, edge information of all of the pixels that constitute the high resolution image is obtained. In other words, the reference pixels of the high resolution image have the first edge orientation and the first edge orientation energy, and the pixels to be interpolated, of the high resolution image have the second edge orientation and the second edge orientation energy.

The pixel value calculator 140 calculates a value of each of the pixels to be interpolated, by using an interpolation filter having a direction and a width determined according to the second edge orientation and the second edge orientation energy of each of the pixels to be interpolated.

As described above, a Gaussian filter is used as the interpolation filter for determining the value of each of the pixels to be interpolated, and the Gaussian filter is an anisotropic Gaussian filter having a direction and a width determined according to edge information. The anisotropic Gaussian filter uses only geometric constraints such as a distance between each of the pixels to be interpolated, and the reference pixels. Thus, blur may occur at a boundary between objects included in an image. The anisotropic Gaussian filter that is used to solve the problem has a width that is adaptively adjusted based on the edge orientation energy.

FIG. 4 illustrates a Gaussian filter used in a pixel to be interpolated. (a) of FIG. 4 illustrates a shape of an isotropic two-dimensional Gaussian filter, and (b) of FIG. 4 illustrates a shape in which the width of the isotropic two-dimensional Gaussian filter in a y-axis direction is reduced. Next, (c) of FIG. 4 illustrates a Gaussian filter having a direction aligned by a rotation matrix.

The pixel value calculator 140 calculates the value of each of the pixels to be interpolated, by using the Gaussian filter having the direction and the width determined adaptively as illustrated in (c) of FIG. 4. The isotropic two-dimensional Gaussian filter may be expressed by using Equation 9:

$$g ( u , v , {σ}_{u} , {σ}_{v} , θ ) = \frac{1}{\sqrt{2 π} {σ}_{u}} exp \{ - \frac{{u}^{2}}{2 {σ}_{u}^{2}} \} * \frac{1}{\sqrt{2 π} {σ}_{v}} exp \{ - \frac{{v}^{2}}{2 {σ}_{v}^{2}} \} , \qquad ( 9 )$$

where an u-axis is an axis that is parallel to a direction θ of the Gaussian filter, and a v-axis is an axis that is perpendicular to the direction θ of the Gaussian filter, and σᵤ is a width of the Gaussian filter in an u-axis direction, and σ_{y} is a width of the Gaussian filter in a v-axis direction.

Also, u and v have the relationship between axes of the high resolution image, as shown in Equation 10:

$$( \begin{matrix}u \\ v\end{matrix} ) = [ \begin{matrix}cos θ & sin θ \\ - sin θ & cos θ\end{matrix} ] ( \begin{matrix}x \\ y\end{matrix} ) , \qquad ( 10 )$$

where an x-axis and a y-axis are axes of the high resolution image.

As shown in Equation 9, the width of the Gaussian filter has the relationship of σᵤ>σᵥ, and the direction θ is the same as the second edge orientation.

Meanwhile, a value of σᵥ, i.e., the width of the Gaussian filter in the direction perpendicular to the second edge orientation may be adaptively adjusted based on the second edge orientation energy. Generally, spatial correlation between values of pixels varies according to a geometric distance. In detail, a value of a pixel that is adjacent to a predetermined pixel may be reasonably estimated. However, the spatial correlation between the values of the pixels at the boundary between objects included in an image is very low and thus blur may occur.

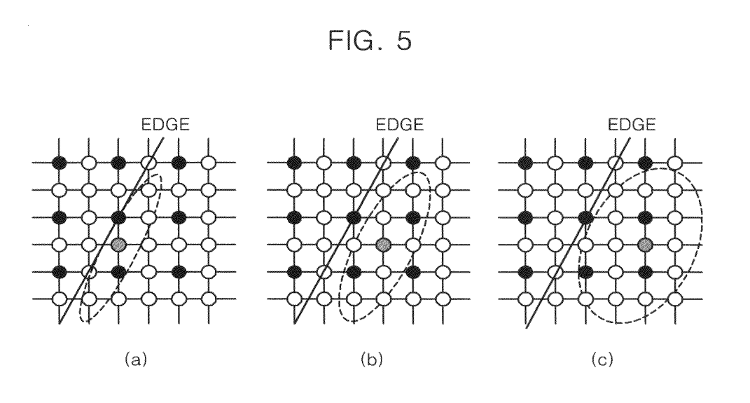

Thus, the pixel value calculator 140 prevents interference between unrelated pixels by adaptively adjusting the width of the Gaussian filter used in each of the pixels to be interpolated, which are disposed at an edge and near the edge. (a) and (b) of FIG. 5 illustrate a case where each of the pixels to be interpolated is close to the edge and illustrate an example in which the width of the Gaussian filter in the direction perpendicular to the second edge orientation is reduced according to a distance between each of the pixels to be interpolated and the edge. (c) of FIG. 5 illustrates a case where each of the pixels to be interpolated is disposed in a flat region that is distant from the edge, and the Gaussian filter has a similar shape to a circular shape as compared to (a) and (b) of FIG. 5.

The spatial correlation between the values of the pixels may be investigated using edge orientation energy. When the value of the edge orientation energy is large, the spatial correlation may be relatively low. The width of the Gaussian filter that is adaptively adjusted according to the spatial correlation is calculated by using Equation 11:

$${\hat{σ}}_{v} = \{ \begin{matrix}{σ}_{v} , & if {E}_{avr} > {β}_{H} ( i , j ) \\ {σ}_{v} \frac{{E}_{avr}}{{β}_{H} ( i , j )} , & otherwise ,\end{matrix} \qquad ( 11 )$$

where \hat{σ}ᵥ is a corrected value with respect to the width of the Gaussian filter in the direction perpendicular to the second edge orientation, and σᵥ is the width of the Gaussian filter in the direction perpendicular to the second edge orientation, and Eₐᵥᵣ is an average of edge orientation energy of all of the pixels that constitute the high resolution image, and β_{H}(i,j) is second edge orientation energy of an (i,j)th pixel to be interpolated, of the high resolution image.

In detail, as shown in Equation 11, when the value of the second edge orientation energy of a pixel to be interpolated is greater than an average of edge orientation energy (the first edge orientation energy of the reference pixels and the second edge orientation energy of pixels to be interpolated) of all of the pixels that constitute the high resolution image, it indicates that the pixel to be interpolated is close to the edge. Thus, the width of the Gaussian filter in the direction perpendicular to the second edge orientation used in each of the pixels to be interpolated is reduced according to Equation 11.

The pixel value calculator 140 calculates the values of the pixels to be interpolated, by using the Gaussian filter having the adaptively adjusted shape by using Equation 12:

$${I}_{H} ( i , j ) = {\sum }_{j = j - N}^{J + N} {\sum }_{i = i - N}^{i + N} {I}_{H} ( i , j ) g ( u , v , {σ}_{u} , {\hat{σ}}_{v} , {α}_{H} ( i , j ) ) , , \qquad ( 12 )$$

where N is a value that indicates the size of the Gaussian filter.

Furthermore, a magnification factor with respect to adjacent pixels may be adaptively selected using a local gradient in consideration of local characteristics of the low resolution image. In the present invention, a reciprocal of the edge orientation energy is used as a weighting factor. The edge detection filter, i.e., the LM filter is used to calculate the first edge orientation and the first edge orientation energy and thus gradient energy may be accurately measured in consideration of the edge orientation. A Gaussian function that is adaptively adjusted by the gradient energy is expressed by using Equation 13:

$$\hat{g} ( u , v , {σ}_{u} , {\hat{σ}}_{v} , θ ) = \frac{{\sum }_{j = j - N}^{J + N} {\sum }_{i = i - N}^{i + N} \frac{{g}_{θ} ( u , v , {σ}_{u} , {\hat{σ}}_{v} )}{{β}_{H} ( i , j )}}{{\sum }_{j = j - N}^{J + N} {\sum }_{i = i - N}^{i + N} \frac{1}{{β}_{H} ( i , j )}} . \qquad ( 13 )$$

As a result, a value of each of the pixels to be interpolated is calculated using the Gaussian filter of Equation 13, by using Equation 14:

$${\hat{I}}_{H} ( i , j ) = {\sum }_{j = j - N}^{J + N} {\sum }_{i = i - N}^{i + N} {I}_{H} ( i , j ) \hat{g} ( u , v , {σ}_{u} , {\hat{σ}}_{v} , {α}_{H} ( i , j ) ) . \qquad ( 14 )$$

As described above, when the high resolution image is generated by enlarging the low resolution image, the Gaussian filter having the adaptively adjusted in consideration of the edge orientation and the edge orientation energy of each pixel is used so that deterioration of image quality such as jagging and blur may be minimized and interpolation of pixel values may be rapidly performed.

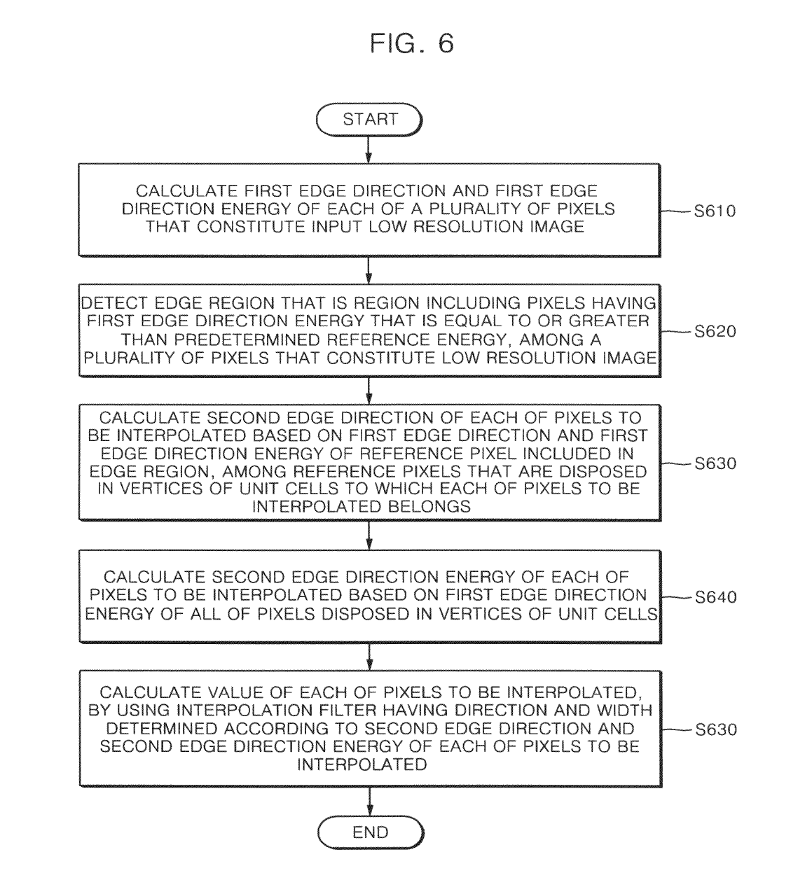

FIG. 6 is a flowchart illustrating an image interpolation method using an anisotropic Gaussian filter according to an embodiment of the present invention. Referring to FIG. 6, in Operation S610, the edge information calculator 110 calculates a first edge orientation that is an orientation of an edge of each of a plurality of pixels that constitute an input low resolution image, and first edge orientation energy that is a maximal strength of an edge corresponding to the first edge orientation. In this case, the LM filter that is an edge detection filter including a plurality of filter banks determined according to an orientation and a scale of an edge is used to calculate edge information. Next, in Operation S620, the edge region detector 120 detects an edge region that is a region including pixels having the first edge orientation energy that is equal to or greater than predetermined reference energy, among a plurality of pixels that constitute the low resolution image.

The image enlarging unit 130 calculates a second edge orientation and second edge orientation energy of each of pixels to be interpolated, which are obtained by subtracting reference pixels corresponding to each of the pixels of the low resolution image among a plurality of pixels that constitute the high resolution image that is obtained by enlarging the low resolution image, based on the first edge orientation and the first edge orientation energy of the adjacent reference pixels. In this case, the image enlarging unit 130 generates a plurality of unit cells in which the adjacent reference pixels are disposed in vertices, and refers the reference pixels corresponding to the vertices of the unit cells to which each of the pixels to be interpolated belongs.

In Operation S630, a second edge orientation of each of the pixels to be interpolated is calculated based on a first edge orientation and first edge orientation energy of a reference pixel included in the edge region, among the reference pixels that are disposed in the vertices of the unit cells to which each of the pixels to be interpolated belongs, and in Operation S640, second edge orientation energy of each of the pixels to be interpolated is calculated based on the first edge orientation energy of all of the pixels disposed in the vertices of the unit cells.

In Operation S650, the pixel value calculator 140 calculates a value of each of the pixels to be interpolated, by using an interpolation filter having a direction and a width determined according to the second edge orientation and the second edge orientation energy of each of the pixels to be interpolated.

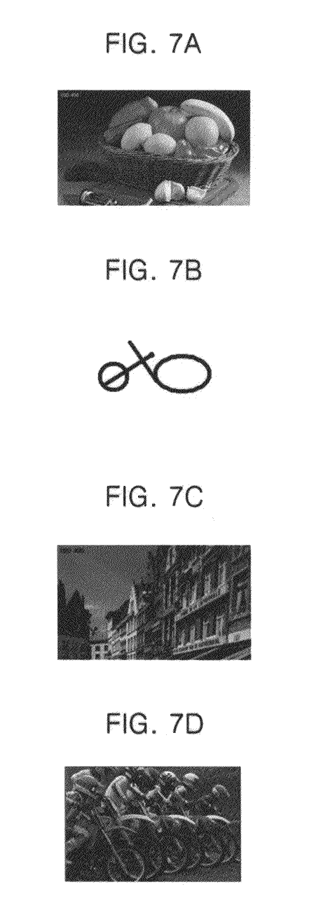

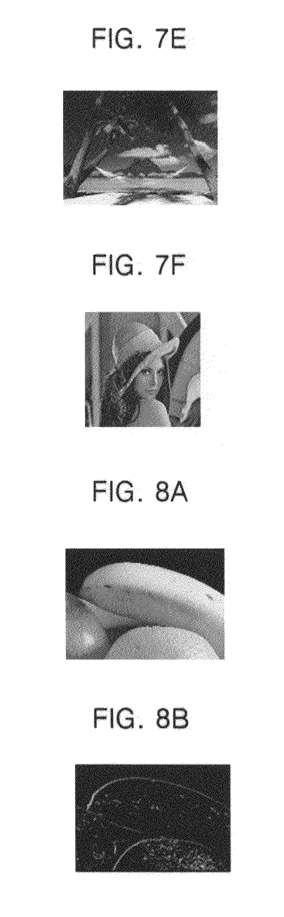

Experiments for evaluating the performance of the image interpolation apparatus of FIG. 1 were carried out. For the experiments, several test images were used. FIGS. 7A through 7F are test images that are used in the experiments for evaluating the performance of the image interpolation apparatus of FIG. 1. Hereinafter, the test images illustrated in FIGS. 7A through 7F are referred to as ‘fruit’, ‘cycle’, ‘cafe’, ‘bike’, ‘Hammock’, and ‘Lena’, respectively. In the experiments, each of the test images of FIGS. 7A through 7F was enlarged twice by a scaling factor 2, and the size of the LM filter and the size of the Gaussian filter before adjustment were set to 5×5. Also, the width of the adjusted Gaussian filter was set to be σᵤ=3σᵥ. The value of reference energy for detecting the edge region for a 8-bit gray scale image was set to 10, and the value of reference energy for detecting the edge region for a 24-bit RGB image was set to 30.

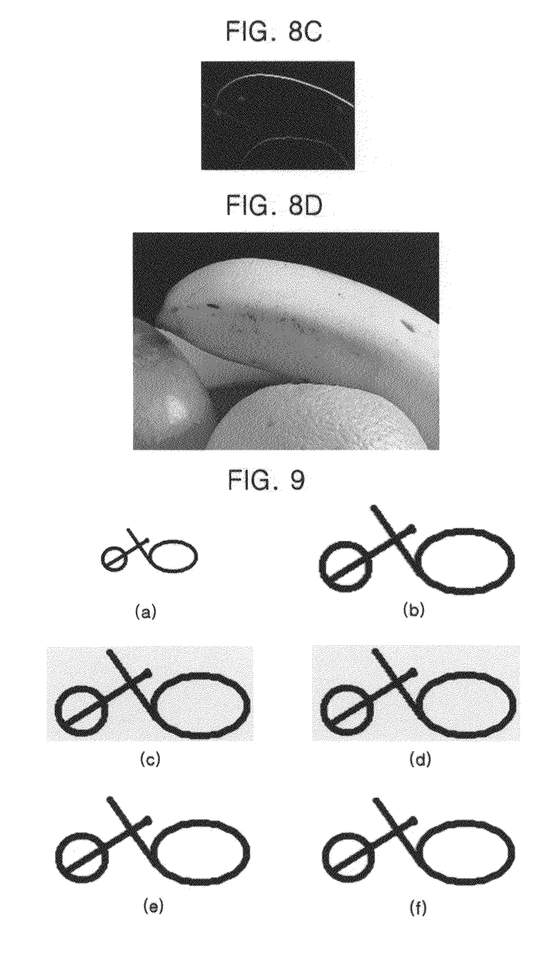

FIGS. 8A through 8D are images that are obtained when the image interpolation apparatus of FIG. 1 is used in the image ‘fruit’ of FIG. 7A, according to operations. FIG. 8A is an original image before enlargement, and FIG. 8B illustrates an edge orientation that is calculated for each pixel. Pixel values that range from 76 to 255 were allocated to an edge orientation that ranges from −90° to 67.5°, and the darkest region indicates a flat region. FIG. 8C illustrates normalized edge orientation energy that is calculated for each pixel. It can be understood from FIG. 8C that the more rapid edge is, the higher edge orientation energy is. FIG. 8D is an image that is obtained by enlarging the original image of FIG. 8A twice, and deterioration of image quality due to image enlargement hardly occurs.

In order to compare the performance of the image interpolation method of FIG. 6 with conventional image interpolation methods, bilinear interpolation, Jensen interpolation, and Li interpolation, and Zhang interpolation were used. The comparison was carried out by comparing peak signal to noise ratio (PSNR) values, and the test images were reduced to generate a low resolution image so as to evaluate a PSNR performance. To this end, an anti-aliasing filter was used in the test images, and the test images were down-sampled by the scaling factor 2. After a high resolution image was generated by using each of the conventional image interpolation methods in the low resolution image, a PSNR was measured so as to compare the high resolution image with original test images. The result of comparison is shown in Table 1.

TABLE 1

| Images | Bilinear | Jensen | Li | Zhang | Present Invention |
|---|---|---|---|---|---|
| Fruit | 29.68 | 30.32 | 30.34 | 30.38 | 30.34 |
| Cycle | 19.56 | 20.26 | 20.84 | 20.67 | 20.74 |
| Cafe | 24.31 | 24.04 | 24.15 | 24.39 | 24.27 |
| Bike | 25.56 | 25.65 | 25.74 | 25.91 | 25.95 |
| Hammock | 27.2 | 27.26 | 27.05 | 27.22 | 27.27 |
| Lena | 32.71 | 32.78 | 32.67 | 32.86 | 33.11 |
| Averages | 26.5 | 26.72 | 26.79 | 26.9 | 26.95 |

As shown in Table 1, the PSNR of portions of the images when the conventional image interpolation methods are used are greater than the PSNR in other portions of the images, and when the image interpolation method according to the present invention is used, a high PSNR value may be obtained.

FIG. 9 is images that are obtained by using the image interpolation method of FIG. 6 and conventional image interpolation methods, respectively, in an image ‘cycle’ having the size of 160×80 of FIG. 7B. (a) through (f) of FIG. 9 represent an original test image, an image that is obtained by using bilinear interpolation, an image that is obtained by using Jensen interpolation, an image that is obtained by using Li interpolation, an image that is obtained by using Zhang interpolation, and an image that is obtained by using the image interpolation method according to the present invention, respectively. The original test image of FIG. 9 is a simple image including a circle, an oval, and two edges of −45° and 60°, and performances of the interpolation methods may be easily compared using the original test image. Referring to FIG. 9, when the image interpolation method according to the present invention is used, jagging and blur hardly occur.

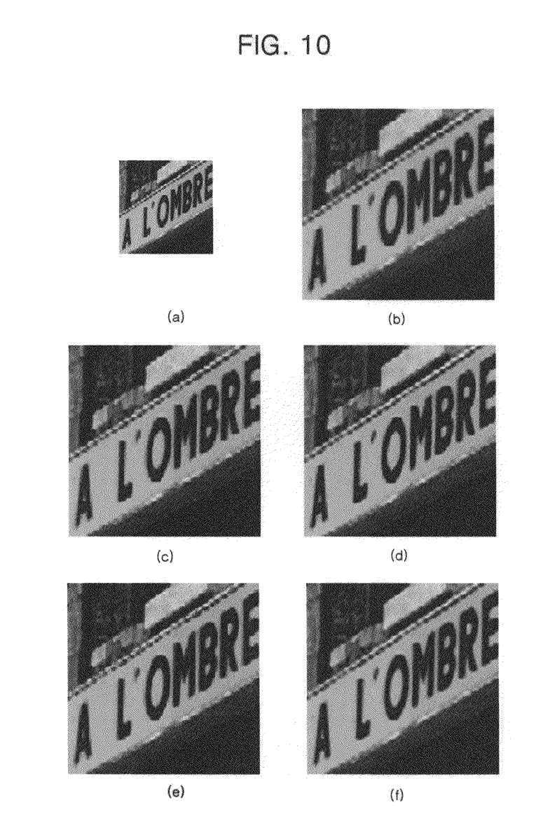

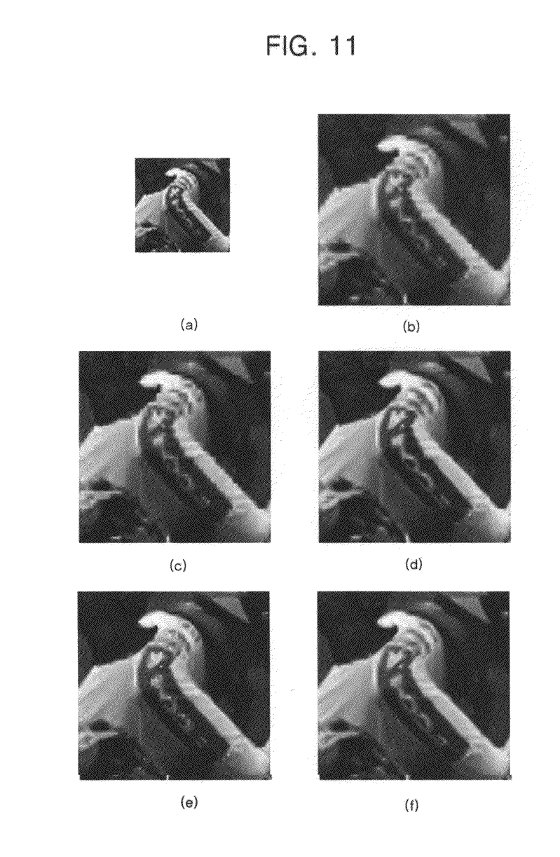

FIG. 10 is images that are obtained by using the image interpolation method of FIG. 6 and the conventional image interpolation methods, respectively, in the image ‘cafe’ of FIG. 7C, and FIG. 11 is images that are obtained by using the image interpolation method of FIG. 6 and the conventional image interpolation methods, respectively, in the image ‘bike’ of FIG. 7D.

Referring to FIGS. 10 and 11, in Jensen interpolation, a sharp edge is preserved at a boundary between objects, and when an edge orientation is not correctly detected, jagging occurs. In particular, Jensen interpolation has a drawback in a region including a pulse-shaped edge. This is because a Sobel-based edge detector may not correctly detect an edge excluding a step edge.

In Li interpolation, an edge is clearly preserved without jagging and blur. However, texture in a region in which correct convariance is not easily obtained is reduced. Furthermore, Li interpolation requires a large amount of calculation. Also, in Zhang interpolation, a clear edge may be generated with a small amount of calculation, and when an unfair weighting factor is selected by LMMSE, speckle noise may occur.

The present invention may generate a high quality high resolution image in which jagging and blur do not frequently occur, as compared to the conventional image interpolation methods.

In an image interpolation apparatus and method using an anisotropic Gaussian filter according to the present invention, a Gaussian filter having a direction and a width that are adaptively adjusted according to an orientation and strength of an edge is used to interpolate values of pixels of a high resolution image that is obtained by image enlargement so that deterioration of image quality can be minimized with a small amount of calculation and an image with high quality and high resolution can be generated.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image interpolation apparatus comprising:
an edge information calculator calculating a first edge orientation that is an orientation of an edge of each of a plurality of pixels that constitute an input low resolution image, and first edge orientation energy that is a maximal strength of the edge corresponding to the first edge orientation;
an image enlarging unit calculating a second edge orientation and second edge orientation energy of each of pixels to be interpolated, which are obtained by subtracting reference pixels corresponding to each of the pixels of the low resolution image among a plurality of pixels that constitute the high resolution image that is obtained by enlarging the low resolution image, based on the first edge orientation and the first edge orientation energy of the adjacent reference pixels; and
a pixel value calculator calculating a value of each of the pixels to be interpolated, by using an interpolation filter having a direction and a width determined according to the second edge orientation and the second edge orientation energy of each of the pixels to be interpolated.

2. The image interpolation apparatus of claim 1, further comprising an edge region detector detecting an edge region that is a region including pixels having the first edge orientation energy that is equal to or greater than predetermined reference energy, among a plurality of pixels that constitute the low resolution image, wherein the image enlarging unit calculates the second edge orientation of each of the pixels to be interpolated, based on a first edge orientation and first edge orientation energy of a reference pixel included in the edge region, among the reference pixels that are disposed in the vertices of the unit cells to which each of the pixels to be interpolated belongs.

3. The image interpolation apparatus of claim 1, wherein the edge information calculator determines an orientation corresponding to a maximal value as the first edge orientation, among energy values according to an orientation and a scale that are calculated by convolution of an edge detection filter including a plurality of filter banks determined according to an orientation and a scale of an edge with each of the pixels that constitute the low resolution image, and determines a maximal value among energy values according to the first edge orientation and the scale as the first edge orientation energy.

4. The image interpolation apparatus of claim 2, wherein the edge information calculator determines an orientation corresponding to a maximal value as the first edge orientation, among energy values according to an orientation and a scale that are calculated by convolution of an edge detection filter including a plurality of filter banks determined according to an orientation and a scale of an edge with each of the pixels that constitute the low resolution image, and determines a maximal value among energy values according to the first edge orientation and the scale as the first edge orientation energy.

5. The image interpolation apparatus of claim 1, wherein the edge enlarging unit generates a plurality of unit cells so that the reference pixels are disposed in vertices of the high resolution image, and calculates a second edge orientation of each of the pixels to be interpolated, based on a first edge orientation and first edge orientation energy of the reference pixels that are disposed in the vertices of the unit cells to which each of the pixels to be interpolated belongs.

6. The image interpolation apparatus of claim 2, wherein the edge enlarging unit generates a plurality of unit cells so that the reference pixels are disposed in vertices of the high resolution image, and calculates a second edge orientation of each of the pixels to be interpolated, based on a first edge orientation and first edge orientation energy of the reference pixels that are disposed in the vertices of the unit cells to which each of the pixels to be interpolated belongs.

7. The image interpolation apparatus of claim 5, wherein, when the pixels to be interpolated are disposed at a boundary of adjacent unit cells, the second edge orientation and the second edge orientation energy are calculated based on a first edge orientation and first edge orientation energy of the reference pixels that are adjacent to each of the pixels to be interpolated along the boundary at which each of the pixels to be interpolated is disposed.

8. The image interpolation apparatus of claim 1, wherein the interpolation filter is a Gaussian filter, and the Gaussian filter has the same direction as the second edge orientation of the pixels to be interpolated, and has a width in the second edge orientation that is greater than a width in a direction perpendicular to the second edge orientation.

9. The image interpolation apparatus of claim 8, wherein, if the second edge orientation energy of the pixels to be interpolated is greater than an average of edge orientation energy of all of pixels that constitute the high resolution image, the width of the Gaussian filter in the direction perpendicular to the second edge orientation is determined as a reduced value due to a ratio of the averages of the edge orientation energy with respect to the second edge orientation energy.

10. An image interpolation method comprising:
calculating a first edge orientation that is an orientation of an edge of each of a plurality of pixels that constitute an input low resolution image, and first edge orientation energy that is a maximal strength of the edge corresponding to the first edge orientation;
calculating a second edge orientation and second edge orientation energy of each of pixels to be interpolated, which are obtained by subtracting reference pixels corresponding to each of the pixels of the low resolution image among a plurality of pixels that constitute the high resolution image that is obtained by enlarging the low resolution image, based on the first edge orientation and the first edge orientation energy of the adjacent reference pixels; and
calculating a value of each of the pixels to be interpolated, by using an interpolation filter having a direction and a width determined according to the second edge orientation and the second edge orientation energy of each of the pixels to be interpolated.

11. The image interpolation method of claim 10, further comprising detecting an edge region that is a region including pixels having the first edge orientation energy that is equal to or greater than predetermined reference energy, among a plurality of pixels that constitute the low resolution image, wherein the calculating of the second edge orientation and the second edge orientation energy of each of pixels to be interpolated comprises calculating the second edge orientation of each of the pixels to be interpolated, based on a first edge orientation and first edge orientation energy of a reference pixel included in the edge region, among the reference pixels that are disposed in the vertices of the unit cells to which each of the pixels to be interpolated belongs.

12. The image interpolation method of claim 10, wherein the calculating of the first edge orientation and the first edge orientation energy comprises determining an orientation corresponding to a maximal value as the first edge orientation, among energy values according to an orientation and a scale that are calculated by convolution of an edge detection filter including a plurality of filter banks determined according to an orientation and a scale of an edge with each of the pixels that constitute the low resolution image, and determining a maximal value among energy values according to the first edge orientation and the scale as the first edge orientation energy.

13. The image interpolation method of claim 11, wherein the calculating of the first edge orientation and the first edge orientation energy comprises determining an orientation corresponding to a maximal value as the first edge orientation, among energy values according to an orientation and a scale that are calculated by convolution of an edge detection filter including a plurality of filter banks determined according to an orientation and a scale of an edge with each of the pixels that constitute the low resolution image, and determining a maximal value among energy values according to the first edge orientation and the scale as the first edge orientation energy.

14. The image interpolation method of claim 10, wherein the calculating of the second edge orientation and the second edge orientation energy of each of pixels to be interpolated comprises generating a plurality of unit cells so that the reference pixels are disposed in vertices of the high resolution image, and calculating a second edge orientation of each of the pixels to be interpolated, based on a first edge orientation and first edge orientation energy of the reference pixels that are disposed in the vertices of the unit cells to which each of the pixels to be interpolated belongs.

15. The image interpolation method of claim 11, wherein the calculating of the second edge orientation and the second edge orientation energy of each of pixels to be interpolated comprises generating a plurality of unit cells so that the reference pixels are disposed in vertices of the high resolution image, and calculating a second edge orientation of each of the pixels to be interpolated, based on a first edge orientation and first edge orientation energy of the reference pixels that are disposed in the vertices of the unit cells to which each of the pixels to be interpolated belongs.

16. The image interpolation method of claim 14, wherein, when the pixels to be interpolated are disposed at a boundary of adjacent unit cells, the second edge orientation and the second edge orientation energy are calculated based on a first edge orientation and first edge orientation energy of the reference pixels that are adjacent to each of the pixels to be interpolated along the boundary at which each of the pixels to be interpolated is disposed.

17. The image interpolation method of claim 10, wherein a Gaussian filter used in each of the pixels to be interpolated has the same direction as the second edge orientation of the pixels to be interpolated, and has a width in the second edge orientation that is greater than a width in a direction perpendicular to the second edge orientation.

18. The image interpolation method of claim 17, wherein, if the second edge orientation energy of the pixels to be interpolated is greater than an average of edge orientation energy of all of pixels that constitute the high resolution image, the width of the Gaussian filter in the direction perpendicular to the second edge orientation is determined as a reduced value due to a ratio of the averages of the edge orientation energy with respect to the second edge orientation energy.

19. A computer readable recording medium having recorded thereon a program for executing the image interpolation method of claim 10.
